(19) United States
(12) Patent Application Publication
(10) Pub. No.: US 2009/0094723 A1
(43) Pub. Date: Apr. 16, 2009

(54) APPAREL FOR PROVIDING LOCATION INFORMATION

(76) Inventor: Ronald J. Doda, JR., Coram, NY (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 11/933,824

(22) Filed: Nov. 1, 2007

(51) Int. Cl. A41D 7/00; A41D 1/00; G01S 5/00

(52) U.S. Cl. 2/67; 2/69; 340/572.1; 342/357.07

(57) ABSTRACT

Disclosed is an apparel comprising a logotype and a tracking device. The logotype uniquely identifies an entity and is displayed on the apparel. The tracking device is configured in the logotype. The tracking device provides location information of a person wearing the apparel.

### FIELD OF THE INVENTION

The present invention generally relates to apparel, and more specifically, to apparel configured with a tracking device.

### BACKGROUND OF THE INVENTION

Apparel for athletes or individuals indulging in a sports activity, are specially designed to provide maximum comfort. These apparels are typically available in a variety of shapes, sizes and designs to cater to a wide range of sports activities.

The sports apparel may be designed with a logotype of a company manufacturing a particular brand of the sports apparel. The logotype provides for easy brand identification and aids in differentiating products from those of competing manufacturers. The use of the logotype for improving style of apparel has largely remained unexplored.

Further, activities such as hiking, fishing and such other adventure activities require specially designed apparel. The apparel may be designed to be resistant to abrasion or may be designed to be waterproof. Such activities include the possibility of a person getting lost while indulging in the activity and as such, may be required to be tracked down. Also, as a safety measure, kids indulging in an activity, such as swimming, may be tracked.

Accordingly, there exists a need for a tracking device to locate a person indulging in a sports activity. There is also a need for including a tracking device in the existing sports apparel, so as to preclude the need for carrying the tracking device separately while indulging in the sporting activity. There is also a need to explore the use of the logotype for improving the style of apparel.

### SUMMARY OF THE INVENTION

An object of the present invention is to track location of a person.

Another object of the present invention is to improve style of an apparel.

In view of the foregoing disadvantages inherent in the prior art, the general purpose of the present invention is to track location of a person using a tracking device configured in a logotype in an apparel, to include all the advantages of the prior art, and to overcome the drawbacks inherent therein. The logotype is displayed on the apparel and uniquely identifies an entity. The tracking device is configured in the logotype. The tracking device provides location information of a person wearing the apparel.

The entity identified by the logotype may include at least one of a professional sports team, a college athletic team and a manufacturer of the apparel. The depiction of a logotype of a professional sports team or even college athletic team, as a logotype on the apparel improves the style of the apparel.

These together with other aspects of the present invention, along with the various features of novelty that characterize the invention, are pointed out with particularity in the claims annexed hereto and form a part of this prevent invention. For a better understanding of the invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts an apparel, in accordance with an exemplary embodiment of the present invention;

FIG. 2 depicts a swimsuit, in accordance with an exemplary embodiment of the present invention; and

FIG. 3 depicts a logotype of a sports team on a swimsuit, in accordance with an exemplary embodiment of the invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a particular automatic tracking and security system, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present invention discloses an apparel comprising a logotype and a tracking device. The logotype uniquely identifies an entity and is displayed on the apparel. The tracking device is configured in the logotype or in the apparel itself. The tracking device provides location information of a person wearing the apparel.

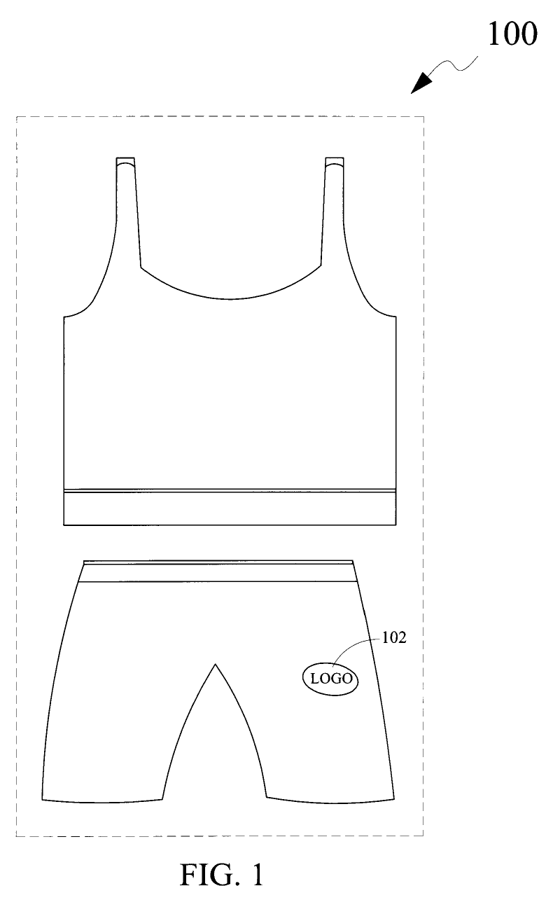

FIG. 1 depicts an apparel 100, in accordance with an exemplary embodiment of the present invention. The apparel 100 includes a logotype 102 displayed on the apparel 100. The logotype 102 will hereinafter be referred to as logo 102. It will be evident to those skilled in the art that the logo 102 may be displayed on the apparel 100 in a variety of ways. Examples of apparel may include a sportswear, a swimsuit, a men's wear, a women's wear, a T-shirt and the like. The logo 102 may be in form of a pictorial design, a slogan or any such other visual representation uniquely identifying an entity. The logo 102 is configured with a tracking device (not shown). The tracking device may be a Global Positioning System (GPS) device, a Radio Frequency Identification (RFID) transponder, an E-Z Pass tag and the like.

The tracking device provides location information of a person wearing the apparel. A person indulging in an adventure activity such as hiking or fishing may get lost and may need to provide location information to personnel who may then provide directions or may dispatch emergency personnel for rescuing the person. Typical tracking devices such as the GPS device uses location information beamed from GPS satellites for tracking purposes. The GPS device uses known techniques such as triangulation for arriving at the location information with a fair amount of accuracy.

It will be evident to those skilled in the art, that the person may use a cellular phone or a computing device such as laptop computer, or a personal digital assistant (PDA), to call a code on the GPS device to arrive at the location information. Further, the GPS tracker may also include components such as a microprocessor, a battery and the like, for performing typical functions of the GPS device. The battery in the GPS device may be a solar powered rechargeable battery. It will be obvious to a person skilled in the art that battery make for providing power to the GPS device may include, but not limited to, a lead-acid based battery, an absorbed glass mat (AGM) based battery, a Nickel Cadmium battery and a Nickel Metal Hydride battery. Further, suitable electrical circuits and electrical connections may be provided to enable functions, such as recharging of the battery by using, for example, solar energy, a DC power input, and the like.

Additionally, the logo 102 includes means for providing water-proof protection to the tracking device for preventing contact of the tracking device with water. For example, the logo 102 may be made of a waterproof material with the tracking device configured therein. More specifically, the logo 102 may comprise a water-proof patch for covering the tracking device, thereby preventing contact of the tracking device with water.

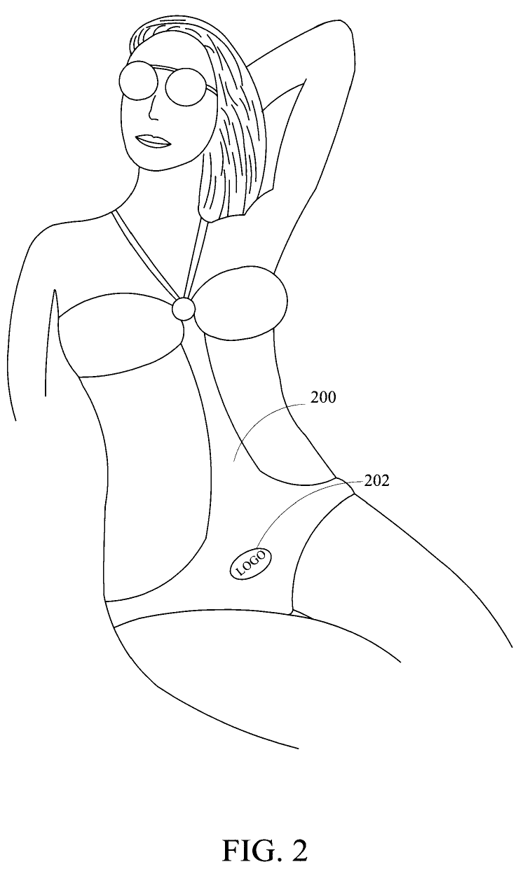

The logo 102 may uniquely identify an entity such as a professional sport team, a college team or even a renowned apparel brand. For instance, the logo 102 may depict a logo of a professional football team such as Oakland Raiders or a professional basketball team such as Los Angeles Lakers or a renowned apparel brand such as Nike, Reebok, Adidas or EMS. The use of logo 102 for depicting the entity improves the style of the apparel 100. An exemplary embodiment of the apparel 100 is described in conjunction with FIG. 2.

FIG. 2 depicts a swimsuit 200, in accordance with an exemplary embodiment of the present invention. The swimsuit 200 includes a logotype 202 displayed on the swimsuit 200. The logotype 202 will hereinafter be referred to as logo 202. It will be evident to those skilled in the art that any design of swimsuit 200 may be possible. For instance, the swimsuit 200 may be a one-piece swimsuit for men, a one-piece swimsuit for women or a two-piece swimsuit for women. Further, it will be obvious to a person ordinarily skilled in the art that the logo 202 may be displayed on the swimsuit in a variety of positions on the swimsuit 200.

The logo 202 is configured with a GPS device (not shown). As explained in conjunction with FIG. 1, the GPS device provides location information of a person such as the person wearing the swimsuit 200. The logo 202 may include provisions for providing water-proof protection to the GPS device, for instance, covering the GPS device with a water-proof patch or any such protection mechanism for preventing contact of the GPS device with water.

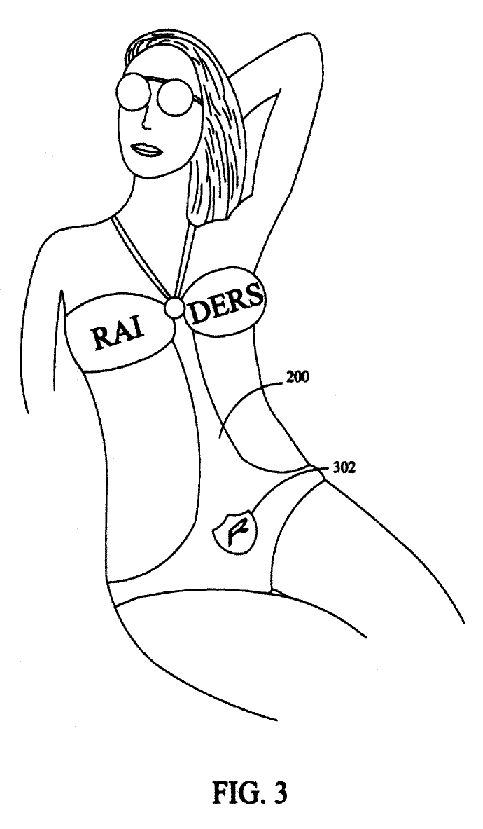

As explained in conjunction with FIG. 1, the logo 202 may uniquely identify a professional sports team or a college athletic team. Such a logo depicting the professional sports team or the college athletic team improves the style of the swimsuit. An example of such a logo is depicted in FIG. 3.

FIG. 3 depicts a logotype 302 of a sports team on the swimsuit 200, in accordance with an exemplary embodiment of the invention. It will be evident to those skilled in the art that the logotype 302 may include any professional sport team, athletic team or any such renowned entity, for improving the style of apparel such as the swimsuit 200.

Apparel, such as the apparel 100, designed with a tracking device provides tracking information of a person wearing the apparel. Individuals indulging in adventure activities may use the apparel as a safeguard to avoid getting lost while on an expedition. The apparel may be designed for children, and parents may use the same to track such children. Furthermore, coastguards and swimmers while on a beach may use swimsuits, such as the swimsuit 200, as a safety measure. The apparel with a logotype configured with a tracking device precludes the need to carry cumbersome additional hardware, thereby permitting an individual to indulge unfettered in an activity. Also, displaying a logotype uniquely identifying an entity such as a professional sports team improves style of the apparel and may appeal to fans of the professional sports team.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and to thereby enable others skilled in the art to best utilize the invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. An apparel comprising:
a logotype uniquely identifying an entity, the logotype capable of being displayed on the apparel; and
a tracking device configured in the logotype;
wherein the tracking device configured in the logotype provides tracking information of the apparel.

2. The apparel of claim 1, wherein the tracking device is at least one of a Global Positioning System (GPS) device, an E-Z Pass Tag and a Radio Frequency Identification (RFID) transponder.

3. The apparel of claim 1, wherein the logotype comprises means for providing waterproof protection to the tracking device configured in the logotype.

4. The apparel of claim 1, wherein the tracking information of the apparel provides location information of a person wearing the apparel.

5. The apparel of claim 1, wherein the apparel is a swimsuit.

6. The apparel of claim 1, wherein the apparel is a sportswear.

7. The apparel of claim 1, wherein the entity is at least one of a professional sport team, a college team and an athletic apparel company.

8. An apparel comprising:
a logotype uniquely identifying an entity, the logotype capable of being displayed on the apparel; and
a Global Positioning System (GPS) device configured in the logotype;
wherein the GPS device configured in the logotype provides tracking information of the apparel.

9. The apparel of claim 8, wherein the apparel is a swimsuit.

10. The apparel of claim 8, wherein the apparel is a sportswear.

11. The apparel of claim 8, wherein the logotype comprises means for providing waterproof protection to the tracking device configured in the logotype.

12. The apparel of claim 8, wherein the tracking information of the apparel provides location information of a person wearing the apparel.

13. The apparel of claim 8, wherein the entity is at least one of a professional sport team, a college team and an athletic apparel company.

14. A swimsuit comprising:
a logotype uniquely identifying an entity, the logotype capable of being displayed on the apparel; and
a Global Positioning System (GPS) device configured in the logotype;
wherein the GPS device configured in the logotype provides tracking information of the swimsuit.

15. The swimsuit of claim 14, wherein the logotype comprises means for providing waterproof protection to the tracking device configured in the logotype.

16. The swimsuit of claim 14, wherein the tracking information of the apparel provides location information of a person wearing the swimsuit.

17. The swimsuit of claim 14, wherein the entity is at least one of a professional sport team, a college team and an athletic apparel company.
